(19) United States
(12) Patent Application Publication
(10) Pub. No.: US 2014/0028530 A1
(43) Pub. Date: Jan. 30, 2014

(54) Bandwidth-Adjustable Dual-Band Antennas with Electromagnetic Wave-Guiding Loop, Methods of Manufacture and Kits Therefor

(71) Applicant: Javier Ruben Flores-Cuadras, Tijuana (MX)

(72) Inventor: Javier Ruben Flores-Cuadras, Tijuana (MX)

(73) Assignee: Taoglas Group Holdings, San Diego, CA (US)

(21) Appl. No.: 13/878,210

(22) PCT Filed: Nov. 18, 2011
(86) PCT No.: PCT/US11/61372

§ 371 Date: Oct. 11, 2013

Related U.S. Application Data
(60) Provisional application No. 61/415,946, filed on Nov. 22, 2010.

(51) Int. Cl. H01Q 5/00

(52) U.S. Cl. CPC H01Q 5/001
USPC 343/904; 343/700 MS

(57) ABSTRACT

A monopole planar inverted-F antenna (PiFA) for dual-band Wi-Fi application is disclosed. The dual band includes a first frequency from 2400-2500 MHz and a second frequency from 4900-6000 MHz. The antenna has a ground copper and a radiation copper. The ground copper is adhered to a substrate having a width of approximately 31 mm and a height of approximately 24 mm. The radiation copper is adhered to the substrate and has a PiFA copper geometry with a width of approximately 31 mm and a height of approximately 6.5 mm. The radiation copper includes a radiation control section that is electrically connected to the ground copper by a short-circuit copper wherein the radiation control section has a length of approximately 15 mm and a width of approximately 0.8 mm.

### CROSS-REFERENCE

This application claims the benefit of U.S. Provisional Application No. 61/415,946, filed Nov. 22, 2010, which application is incorporated herein by reference.

### BACKGROUND OF THE INVENTION

1. Field of the Invention

The present invention relates in general to an antenna and, in particular, to a planar antenna. More particularly, the present invention relates to a bandwidth-adjustable dual-band antenna having an electromagnetic wave-guiding loop for wireless applications such as Wi-Fi™, wireless HDTV, Bluetooth, Public Safety, RFID, tolling, WiMAX, remote control and unlicensed band wireless applications. The invention is suitable for use in any wireless application which uses 2400-2500 MHz and 4900-6000 MHz bands.

2. Background of the Invention

In recent years there has been a tremendous increase in the use of wireless devices. The increased use has filled all or nearly all existing frequency bands. As a result, new wireless frequency standards continue to emerge throughout the world.

Based on the IEEE 802.11 standards, Wi-Fi™ has become the de facto standard for wireless local area network (WLAN) devices, which includes cell phones, smart phones and PDA devices, and laptop and desktop personal computers. Extensive efforts have been devoted to the development of an antenna that can be used to cover the entire frequency range of the latest Wi-Fi™ standard to keep overall device costs down.

For the latest dual-band Wi-Fi antennas, increased interference is problematic in the 2.4 and 5 GHz frequency modes. It has also been difficult for a single antenna to be optimized for both frequency modes. Currently antennas are either optimized for one frequency or another or performance in both modes results in poor efficiency. Previously disclosed planar antennas include, for example, those disclosed in U.S. Pat. Nos. 6,917,339 B2 to Li et al. for Multi-Band Broadband Planar Antennas; 6,346,914 B1 to Annamaa for Planar Antenna Structure

What is needed is a relatively small-sized dual-band antenna that is bandwidth adjustable and which operates efficiently in more than one bandwidth. Additionally, what is needed is an antenna that does not need to couple to the device ground-plane to radiate efficiently in an omni-directional pattern.

### SUMMARY OF THE INVENTION

An aspect of the disclosure is directed to a planar antenna. Suitable antennas comprise, for example, a substrate having a substantially square shape; a conductive layer attached to a first surface of the substrate wherein the conductive layer further comprises an antenna section which includes a monopole planar inverted-F antenna adapted and configured to efficiently operate in a dual band mode and a radiation control section, and a ground section connected to the inverted-F antenna by a connector region. Additionally, the antenna section and the ground section can be fashioned from a layer of patterned foil adhered to the first surface of the substrate. The antenna typically has an overall width of from about 20 mm to 40 mm and a height of from about 20 mm to about 40 mm, more preferably from about 31 mm and a height of about 31 mm, or any combination of sizes therein to within 0.001 mm. The antenna thickness typically ranges from about 0.05 mm to about 0.15 mm, and more preferably about 0.1 mm, or any combination of sizes therein to within 0.001 mm. Additionally, the antenna section can be configured such that the comprises a first horizontally longer section at a first end and a parallel shorter section below the first horizontally longer section, wherein the second section is proximal the ground element. Additionally, the substrate can be at least one of a Flame Retardant 4 material, a flexible printed circuit substrate, and a single-side printed circuit board substrate. Moreover, the conductive layer is selected from the group comprising copper, aluminum, nickel, and chrome. Typically an insulation layer sits on top of the conductive layer. The insulation layer can have an aperture defining a ground point exposing a portion of the ground element. Additionally, the insulation layer can have an aperture defining a feed point exposing a portion of the radiation element. The antennas are also configurable to operate in a dual band mode which includes a first frequency from 2400-2500 MHz and a second frequency from 4900-6000 MHz.

Another aspect of the disclosure provides for a planar antenna manufactured by patterning a substrate comprising a dielectric layer, and a conductive layer applied to at least one surface of the substrate. Suitable planar antennas manufactured by patterning a substrate comprise, for example, a substrate having a substantially square shape; a conductive layer attached to a first surface of the substrate wherein the conductive layer further comprises an antenna section which includes a monopole planar inverted-F antenna adapted and configured to efficiently operate in a dual band mode and a radiation control section, and a ground section connected to the inverted-F antenna by a connector region. Additionally, the antenna section and the ground section can be fashioned from a layer of patterned foil adhered to the first surface of the substrate. The antenna typically has an overall width of from about 20 mm to 40 mm and a height of from about 20 mm to about 40 mm, more preferably from about 31 mm and a height of about 31 mm, or any combination of sizes therein to within 0.001 mm. The antenna thickness typically ranges from about 0.05 mm to about 0.15 mm, and more preferably about 0.1 mm, or any combination of sizes therein to within 0.001 mm. Additionally, the antenna section can be configured such that the comprises a first horizontally longer section at a first end and a parallel shorter section below the first horizontally longer section, wherein the second section is proximal the ground element. Additionally, the substrate can be at least one of a Flame Retardant 4 material, a flexible printed circuit substrate, and a single-side printed circuit board substrate. Moreover, the conductive layer is selected from the group comprising copper, aluminum, nickel, and chrome. Typically an insulation layer sits on top of the conductive layer. The insulation layer can have an aperture defining a ground point exposing a portion of the ground element. Additionally, the insulation layer can have an aperture defining a feed point exposing a portion of the radiation element. The antennas are also configurable to operate in a dual band mode which includes a first frequency from 2400-2500 MHz and a second frequency from 4900-6000 MHz.

Yet another aspect of the disclosure provides for an antenna kit. The antenna kit comprises: a planar antenna comprising a substrate having a substantially square shape, a conductive layer attached to a first surface of the substrate wherein the conductive layer further comprises an antenna section which includes a monopole planar inverted-F antenna adapted and configured to efficiently operate in a dual band mode and a radiation control section, and a ground section connected to the inverted-F antenna by a connector region. Additional components of the kit can include, for example, a flexible cable adaptable to connect the planar antenna to a target device and/or mounting material.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIGS. 1a-e illustrate a planar antenna in accordance with the disclosure; FIG. 1a illustrates a top planar view of the antenna; FIG. 1b illustrates a cross-sectional side view along the lines 1b-1b of FIG. 1a; FIG. 1c illustrates a cross-sectional side view along the lines 1c-1c of FIG. 1a; FIG. 1d illustrates a cross-sectional side view along the lines 1d-1d of FIG. 1a; FIG. 1e illustrates an expanded view of the substrate and antenna layers;

FIG. 2 shows the simulation result of current distribution for the antenna of FIGS. 1a-d working in the 2.4 GHz Wi-Fi mode;

FIG. 3 shows the simulation result of current distribution for the antenna of FIGS. 1a-d working in the 5 GHz Wi-Fi mode;

FIG. 4 illustrates an antenna segment responsible for bandwidth and efficiency adjustment of the antenna of FIGS. 1a-d;

FIG. 5 shows the gain characteristic of the antenna of FIGS. 1a-d working under the 2.4 GHz Wi-Fi mode; and

FIG. 6 shows the gain characteristic of the antenna of FIGS. 1a-d working under the 5 GHz Wi-Fi mode.

### DETAILED DESCRIPTION OF THE INVENTION

The disclosure provides a dual-band antenna that has cancelled electromagnetic interference suitable for use in any wireless application which uses 2400-2500 MHz and 4900-6000 MHz bands. Wireless applications include, for example, Wi-Fi™, wireless HDTV, Bluetooth, Public Safety, RFID, tolling, remote control and unlicensed band wireless applications.

Wi-Fi™ is a trademark of the Wi-Fi Alliance and typically refers only to a narrow range of connectivity technologies including wireless local area networks (WLAN) based on the IEEE 802.11 standards, device-to-device connectivity (such as Wi-Fi peer-to-peer), and a range of technologies that support personal area networks (PAN), local area networks (LAN) and WAN connections. Wi-Fi has become a superset of IEEE 802.11.

As will be appreciated by those skilled in the art, the disclosure herein enables a dual-band Wi-Fi antenna that has optimized antenna efficiency and performance for both modes of Wi-Fi antenna operation. Moreover, the optimized antenna efficiency can be achieved simultaneously.

### I. Antennas

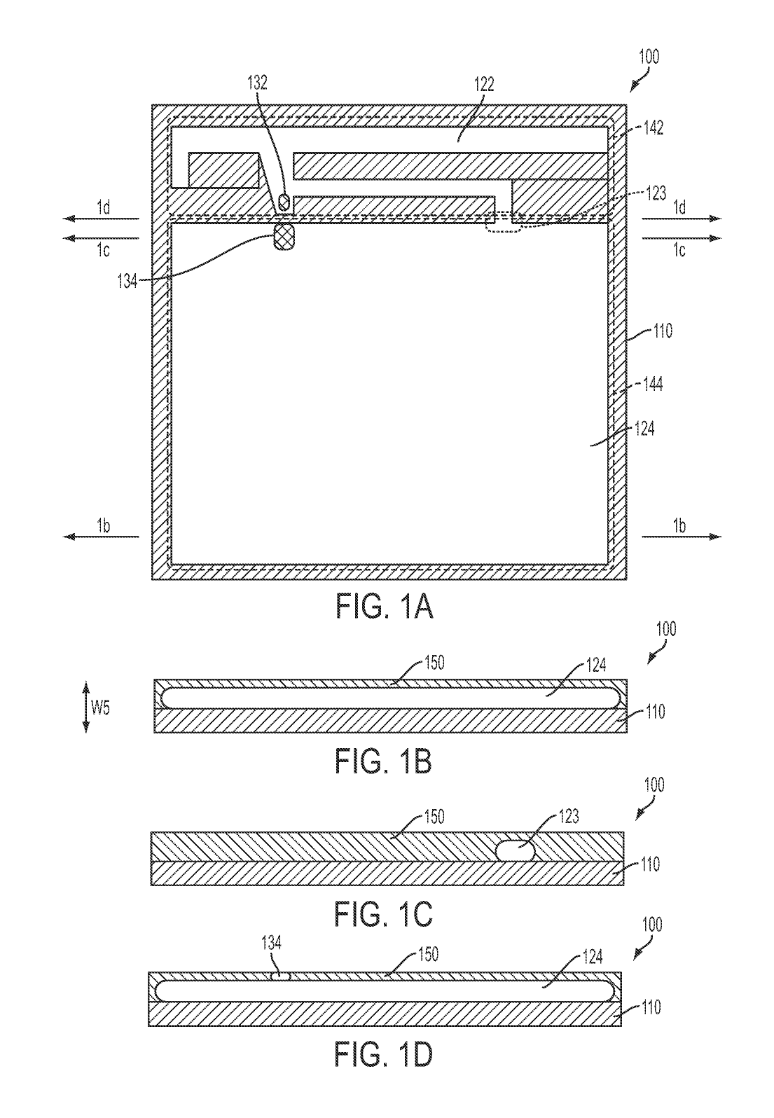

FIG. 1a illustrates a top view of a planar antenna. The antenna 100 has a monopole planar inverted-F antenna (PiFA). As is illustrated, the antenna 100 has a ground element section 144 and an antenna section 142. Each of these sections—with its electrically conductive layer of a correspondingly specific shaping—is, typically, a layer of copper foil adhered to the surface of a suitable substrate 110.

A short-circuit section 123 is positioned between the radiation element 122 and the ground element 124 which causes the ground element 124 to become radiating. This ground element 124 serves to establish an electromagnetic wave grounding loop for antenna 100 and thereby reduces and effectively cancels electromagnetic interference in the antenna. The short-circuit section or connector region 123 also allows the antenna circuitry to achieve better impedance matching. Impedance matching can, for example, be optimized to 50-ohm impedance.

The ground element 124 can further be masked by a protective layer 150 leaving only a ground point 134 exposed. Similarly, the radiation element 122 of the antenna section 142 can be adapted and configured to provide an unmasked feed point 132. The ground point 134 and feed point 132 can provide a location for the antenna to achieve an electrical connection to the antenna circuitry of the electronic equipment relying on the antenna for electromagnetic signal transmission and reception.

Turning now to FIGS. 1b-d, a substrate 110 is provided upon which the antenna element sits. A top insulation layer 150 can also be provided to electrically isolate, or selectively electrically isolate, the antenna element from the surrounding area. As shown in FIG. 1b, which is a cross-section of the antenna taken along the lines 1b-1b of FIG. 1a, the ground element 124 of the antenna sits atop the substrate 110 and is covered by an insulation layer 150. As can be seen in the cross-section shown in FIG. 1c, which is a cross-section of the antenna taken along the lines 1c-1c of FIG. 1a, the entire surface of the substrate 110 is covered the insulation layer 150 and short-circuit section or connector region 123 is positioned near one end of the device. Turning now to the cross-section shown in FIG. 1d, an opening in the insulation layer 150 is provided which provides a ground access point 134 to the ground element 124. The overall thickness of the antenna ranges from 0.05 mm to 0.15 mm, more preferably 0.08 mm to 0.12 mm, and even more preferably 0.10 mm.

Turning now to FIG. 1e, the ground element 124 and radiation element 122 of suitable material, such as copper, is sized to be positioned on a substrate 110. The overall dimensions of the combined ground element 124 and radiation element 122 is L1 along one axis and W1 along a second access, where L1 typically ranges from 20 mm to 40 mm, more preferably from 28 mm to 35 mm, and even more preferably about 31 mm, and W1 typically ranges from 20 mm to 60 mm, more preferably from 25 mm to 35 mm, and even more preferably about 31 mm. The ground element 124 alone typically has an overall dimensions of L1 along one axis and W2 along a second access, where L1 typically ranges from 20 mm to 40 mm, more preferably from 28 mm to 35 mm, and even more preferably about 31 mm, and W2 typically ranges from 15 mm to 54 mm, more preferably from 20 mm to 30 mm, and even more preferably about 24 mm. The ground element 124 is generally rectangular. The ratio of the lengths of L1 to W1 is from about 0.9:1.1 more preferably about 0.95:1.05 and even more preferably about 1:1. The ratio of the lengths of W2 to W3 is preferably 2:5 and even more preferably about 1:4. The ratio of the lengths of L1 and L4 is preferably about 1:2.

The radiation element 122 alone typically occupies a space within an overall dimension of L1 along one axis and W3 along a second access, where L1 typically ranges from 20 mm to 40 mm, more preferably from 28 mm to 35 mm, and even more preferably about 31 mm, and W3 typically ranges from 4 mm to 12 mm, more preferably from 5 mm to 8 mm, and even more preferably about 6.5 mm. The length for the radiation element can, but need not be, substantially the same as the ground element 124. Moreover, the radiation element 122, has a geometry commonly found in a PiFA. Thus the radiation element 122 has a horizontally longer, wider element 154 at a first end and a parallel and relatively shorter, narrower element 156 below. The radiation element 122 is in electrical communication with a ground section 144 via a connector region 123 which is identified by a phantom-line circle. The connector region 123 is inset from a side of the antenna a distance of L5, wherein L5 ranges from 4 mm to 1 mm, and more preferably about 1 mm.

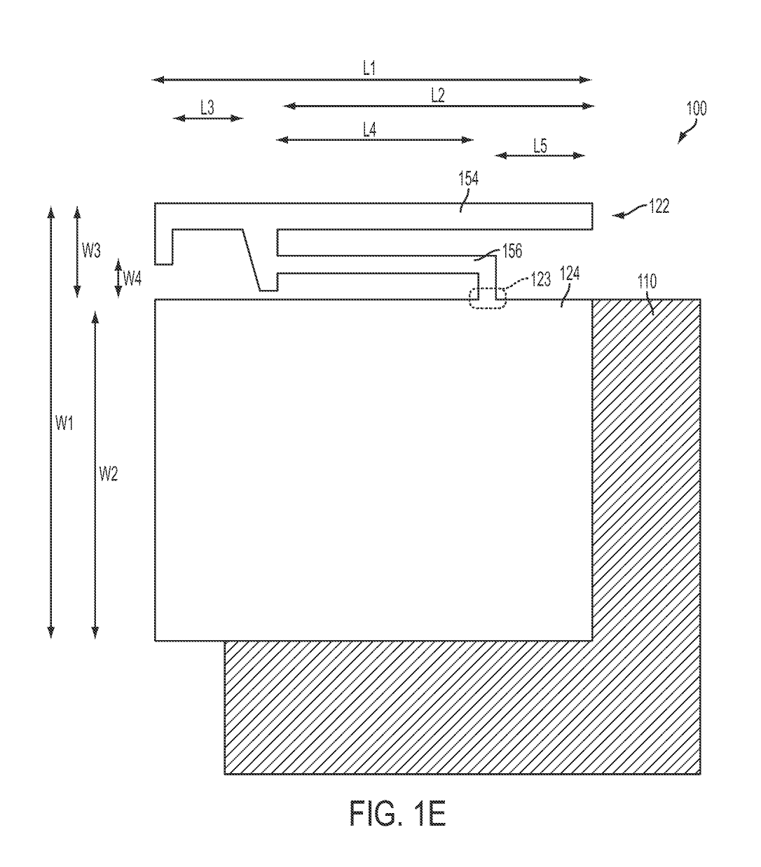

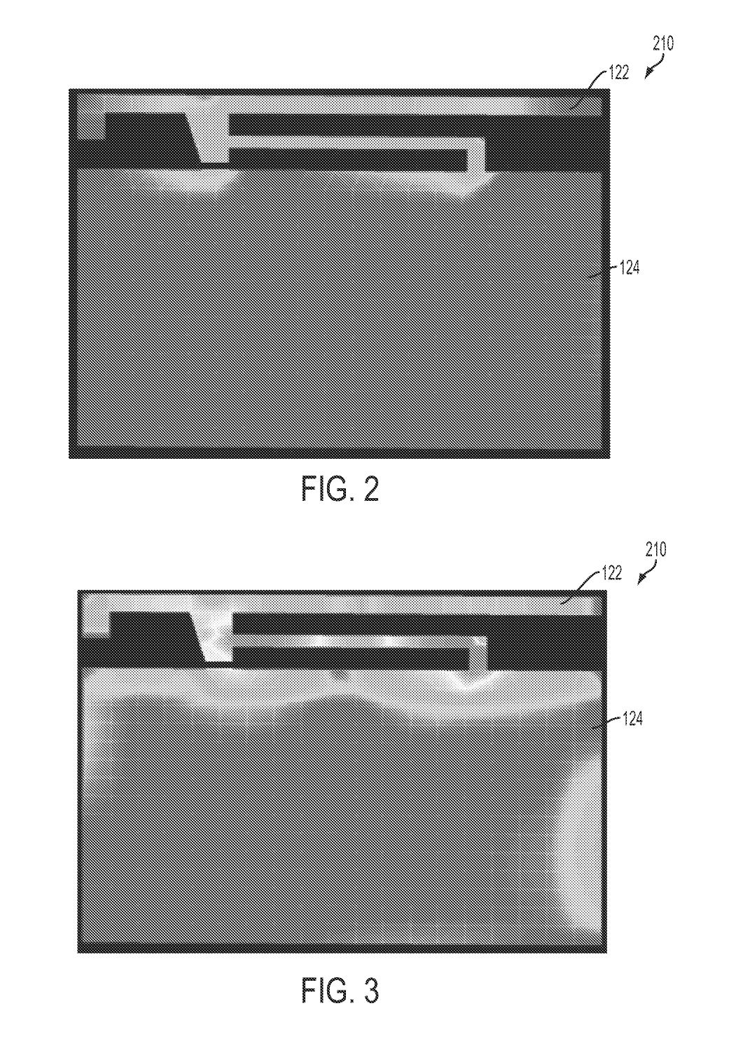

FIG. 2 shows the simulation result of current distribution for an antenna constructed according to FIGS. 1a-d wherein the antenna is operating in a 2.4 GHz Wi-Fi mode. FIG. 3 shows the simulation result of current distribution for an antenna of FIGS. 1a-d operating in a 5 GHz Wi-Fi mode. These simulations illustrate that the largest antenna current 210 occurs in the shorter and narrower horizontal section of the radiation element 122.

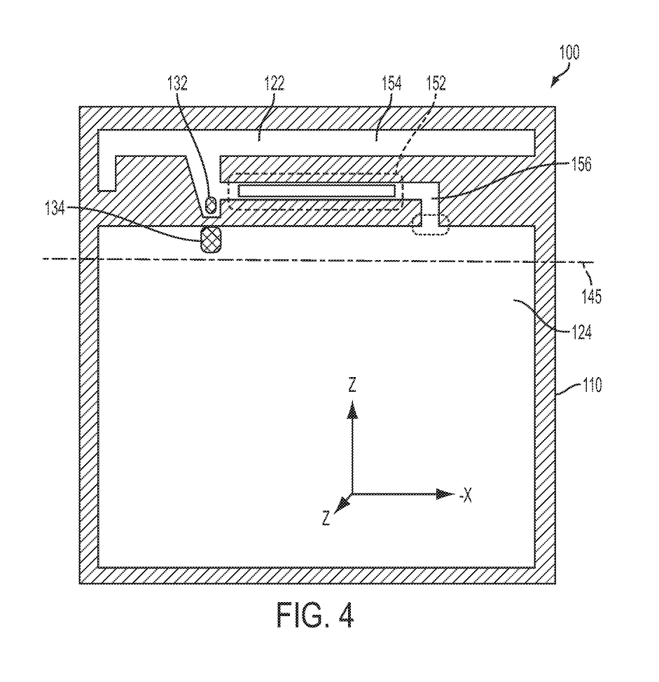

FIG. 4 illustrates an antenna segment wherein a radiation control section 152 of the radiation element 122 identified by shading and outlined in a phantom-line, is responsible for bandwidth and efficiency adjustment of the antenna 100 during operation. As will be appreciated by those skilled in the art, the physical dimensions of the radiation control section 152 of the radiation element 122 can be used as control factors for performance adjustment of antenna 100. Performance characteristics including the operating frequency bandwidth, the antenna electrical characteristics and operating efficiency can be tweaked for the 2.4 and 5 GHz bands of the antenna 100 in Wi-Fi applications.

For example, the wider the width of the radiation control section 152 (in the vertical direction of FIG. 4), the narrower the frequency bands (for both the 2.4 and 5 GHz modes), while the narrower the width of radiation control section 152, the wider the frequency bands. Thus, the length of the radiation control section 152 can be used to control shifting of a central frequency of the Wi-Fi operating bands. Meanwhile, length of the radiation control section 152 can also affect the radiation and reception efficiency of antenna 100.

Additional and large metallic plates or electrically conductive structural planes of the electronic equipment that hosts the antenna 100 can be positioned in electrical contact with the ground element 124 generally in the area below the line 145 to further improve the efficiency of the antenna. Such boost contact can be simply in the form of adherence, soldering or welding is not necessary.

An antenna 100 configured for optimized dual-band Wi-Fi applications typically has a radiation control section 152 that has a length of L4 along one axis and W4 along a second axis, where L4 typically ranges from 10 mm to 24 mm, more preferably from 13 mm to 17 mm, and even more preferably about 15 mm and a W4 typically ranges from 2 mm to 5 mm, more preferably from 3 mm to 4 mm, and even more preferably of 2.75 mm. Boundary line 145 for efficiency boost plane typically has a minimum distance of about from about 2 mm to about 8 mm, more preferably from about 3 mm to about 5 mm, and even more preferably about 4 mm from a boundary of antenna section 142 positioned near the ground section 144 of the antenna 100.

### II. Operation and Use of the Antennas

The antenna can be provided with a flexible cable adapted and configured to connect the antenna to the electronics of the target device, such as a mobile phone. Alternatively, the antenna can be configured such that no cable is required to connect the antenna to the target device. For a cable-less antenna, pads are provided on the antenna which provide connections from a module or transmission line via metal contacts or reflow solder.

The antenna can be affixed to a housing of a target device, such as an interior surface of a cell phone housing. Affixing the antenna can be achieved by using suitable double sided adhesive, such as 3M™ Adhesive Transfer Tape 467 MP available from 3M.

As will be appreciated by those skilled in the art, the larger the antenna surface area (or volume), in general the higher the performance in terms of gain and radiation characteristics. Additionally, the gain of the antenna is closely linked to the surface area or volume of the antenna. Thus, the larger the surface area or volume, the higher the gain. In deploying the antenna, clearances can be provided to optimize performance of the antenna. As will be appreciated by those skilled in the art, the larger the clearance, the better the radiation characteristics of the antenna.

### III. Method of Manufacturing the Antennas

The features and functions of the antennas described herein allow for their use in many different manufacturing configurations. For example, in a wireless communication handheld device (e.g. a mobile phone), an antenna can be printed on any suitable substrate including, for example, printed circuit boards (PCB) or flexible printed circuits (FPC). The PCB or FPC is then used to mechanically support and electrically connect the antenna to the electronics of the device deploying the antenna using conductive pathways. tracks or signal traces etched from copper sheets, for example, that has been laminated onto a non-conductive substrate. The printed piece can then be mounted either at the top of the handset backside or at the bottom of the front side of the handset. Thus, antennas 100 according to this disclosure can be manufactured, for example, using a standard low-cost technique for the fabrication of a single-side printed circuit board. Other manufacturing techniques may be used without departing from the scope of the disclosure.

Techniques for manufacturing antennas include determining which materials, processes will be followed. For example, a printed circuit board (PCB), an electrically thin dielectric substrate (e.g., RT/diroid 5880), Flame Retardant 4 (FR-4) material complying with the UL-94-V0, or any suitable non-conductive board can be used as the substrate. A conductive layer is provided from which the antenna will be formed. The conductive layer is generally copper, but other materials can be used without departing from the scope of the disclosure. For example, aluminum, silver, chrome, and other metals or metal alloys can be used.

Data for identifying a configuration for the antenna layer is provided which can then be placed onto an etch resistant film that is placed on the conductive layer which will form the antenna. A traditional process of exposing the conductive layer, and any other areas unprotected by the etch resistant film, to a chemical that removes the unprotected conductive layer, leaving the protected conductive layer in place. As will be appreciated by those skilled in the art, newer processes that use plasma/laser etching instead of chemicals to remove the conductive material, thereby allowing finer line definitions, can be used without departing from the scope of the disclosure.

Multilayer pressing can also be employed which is a process of aligning the conductive material and insulating dielectric material and pressing them under heat to activate an adhesive in the dielectric material to form a solid board material. In some instances, holes can be drilled for plated through applications and a second drilling process can be used for holes that are not to be plated through.

Plating, such as copper plating, can be applied to pads, traces, and drilled through holes that are to be plated through. The antenna boards can then be placed in an electrically charged bath of copper. A second drilling can be performed if required. A protective masking material can then be applied over all or select portions of the bare conductive material. The insulation protects against environmental damage, provides insulation, and protects against shorts. Coating can also be applied, if desired. As a final step, the markings for antenna designations and outlines can be silk-screened onto the antenna. Where multiple antennas are manufactured from a panel of identical antennas, the antennas can be separated by routing. This routing process also allows cutting notches or slots into the antenna if required.

As will be appreciated by those skilled in the art, a quality control process is typically performed at the end of the process which includes, for example, a visual inspection of the antennas. Additionally, the process can include the process of inspecting wall by cross-sectioning or other methods. The antennas can also be checked for continuity or shorted connections by, for example, applying a voltage between various points on the antenna and determining if a current flow occurs. The correct impedance of the antennas at each frequency point can be checked by connecting to a network analyzer.

### IV. Kits

The antennas disclosed herein can be made available as part of a kit. The kit comprises, for example, a planar antenna comprising a substrate having a substantially square shape, a conductive layer attached to a first surface of the substrate wherein the conductive layer further comprises an antenna section which includes a monopole planar inverted-F antenna adapted and configured to efficiently operate in a dual band mode and a radiation control section, and a ground section connected to the inverted-F antenna by a connector region, and a flexible cable adaptable to connect the planar antenna to a target device. Additionally, the kit may include, for example, suitable mounting material, such as 3M adhesive transfer tape. Other components can be provided in the kit as well to facilitate installation of the antenna in a target device. The kit can be packaged in suitable packaging to allow transport. Additionally, the kit can include multiple antennas, such that antennas and cables are provided as 10 packs, 50 packs, 100 packs, and the like.

### V. Examples

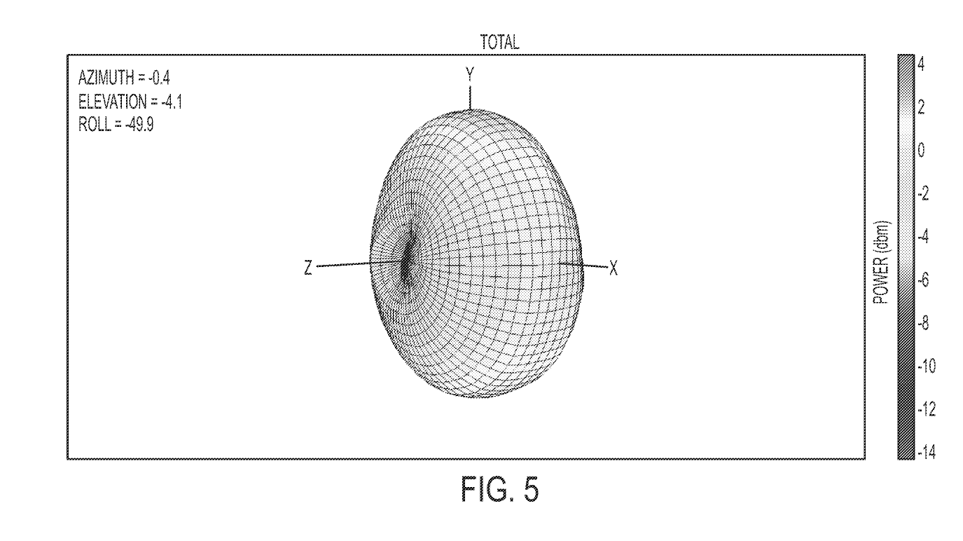

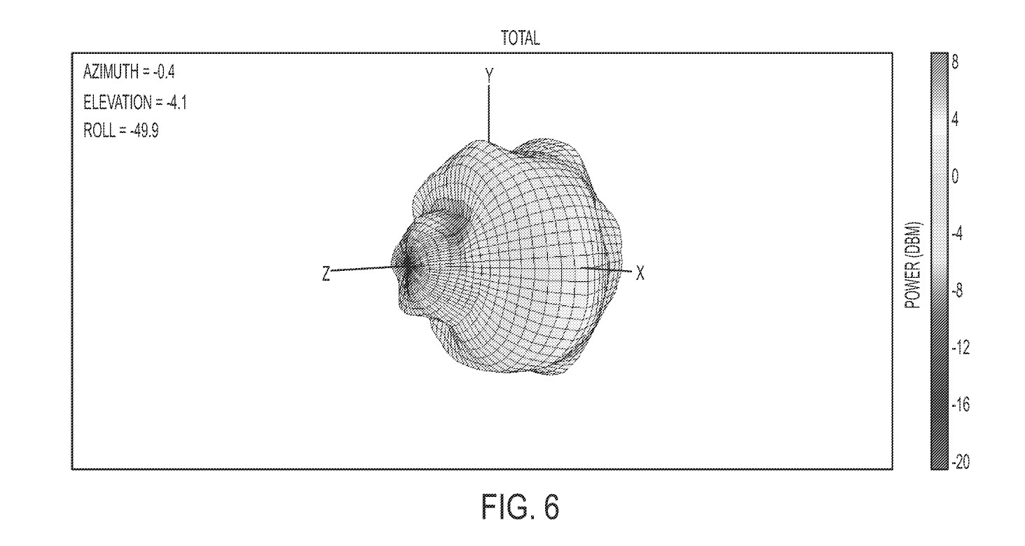

Experimental antennas according to this disclosure have been constructed and tested. FIG. 5 shows an actual measured gain characteristic of an embodiment of an antenna 100 operating in the 2.4 GHz Wi-Fi mode, and FIG. 6 shows a gain characteristic of the same antenna operating in the 5 GHz Wi-Fi mode. Antenna 100 was tested in a lab with an antenna 100 orientation as described in FIG. 4. TABLE 1 lists the performance specification of the antenna measured in FIGS. 5 and 6.

TABLE 1
SPECIFICATION OF AN EXPERIMENTAL ANTENNA

| Standard | Bluetooth | 2.4 GHz Wi-Fi | 5 GHz Wi-Fi | Other 5 GHz |
|---|---|---|---|---|
| Band (MHz) | 2,401-2,480 | 2,400-2,500 | 5,725-5,825 | 4,900-5,900 |
| Peak Gain | 1 | 1 | 6 | 7 |
| (dBi) | | | | |

| | | |
|---|---|---|
| Average | −2 | 0 |
| Gain (dB) | | |
| Efficiency | 60-70% | 80-95% |
| (%) | | |

As discussed above, the gain of the antenna is closely linked to the surface area or volume of the antenna. Moreover, the antenna efficiency directly relates to the actual measured radiated power and sensitivity of the wireless device it is placed into (the TRP/TIS results). The higher the efficiency, given a well matched antenna and device, the better the range and sensitivity of the device, the higher the data transfer speed, and the less power is consumed by the device. For antennas built under the designs disclosed herein, the efficiency remains high in both the 2.4 GHz and 5 GHz ranges, given the relatively small size of the antenna.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A planar antenna comprising:
a substrate having a substantially square shape;
a conductive layer attached to a first surface of the substrate wherein the conductive layer further comprises an antenna section which includes a monopole planar inverted-F antenna adapted and configured to efficiently operate in a dual band mode and a radiation control section, and a ground section connected to the inverted-F antenna by a connector region.

2. The antenna of claim 1 wherein each of the antenna section and the ground section is a layer of patterned foil adhered to the first surface of the substrate.

3. The antenna of claim 1 wherein the antenna section and the ground section have a combined overall width of from about 20 mm to 40 mm and a height of from about 20 mm to about 40 mm.

4. The antenna of claim 1 wherein the antenna section and the ground section have a combined overall width of from about 31 mm and a height of about 31 mm.

5. The antenna of claim 1 wherein the antenna section and the ground section adhered to the substrate have a combined overall thickness of from about 0.05 mm to about 0.15 mm.

6. The antenna of claim 1 wherein the antenna section and the ground section adhered to the substrate have a combined overall thickness of about 0.1 mm.

7. The antenna of claim 1 wherein the antenna section has a radiation element further comprising a first horizontally longer section at a first end and a parallel shorter section below the first horizontally longer section, wherein the second section is proximal the ground element.

8. The antenna of claim 1 wherein the substrate is at least one of a Flame Retardant 4 material, a flexible printed circuit substrate, and a single-side printed circuit board substrate.

9. The antenna of claim 1 wherein the conductive layer is selected from the group comprising copper, aluminum, silver, nickel, and chrome.

10. The antenna of claim 1 further comprising an insulation layer on top of the conductive layer.

11. The antenna of claim 10 wherein the insulation layer has an aperture defining a ground point exposing a portion of the ground element.

12. The antenna of claim 10 wherein the insulation layer has an aperture defining a feed point exposing a portion of the radiation element.

13. The antenna of claim 1 wherein the dual band includes a first frequency from 2400-2500 MHz and a second frequency from 4900-6000 MHz.

14. A planar antenna manufactured by patterning a substrate comprising a dielectric layer, and a conductive layer applied to at least one surface of the substrate, comprising:
an antenna section which includes a monopole planar inverted-F antenna adapted and configured to efficiently operate in a dual band mode, a radiation control section, and a ground section connected to the inverted-F antenna by a connector region,
wherein the substrate has a substantially square shape.

15. The antenna of claim 14 wherein each of the antenna section and the ground section is a layer of patterned foil adhered to the first surface of the substrate.

16. The antenna of claim 14 wherein the antenna section and the ground section have a combined overall width of from about 20 mm to 40 mm and a height of from about 20 mm to about 40 mm.

17. The antenna of claim 14 wherein the antenna section and the ground section have a combined overall width of from about 31 mm and a height of about 31 mm.

18. The antenna of claim 14 wherein the antenna section and the ground section adhered to the substrate have a combined overall thickness of from about 0.05 mm to about 0.15 mm.

19. The antenna of claim 14 wherein the antenna section and the ground section adhered to the substrate have a combined overall thickness of about 0.1 mm.

20. The antenna of claim 14 wherein the antenna section has a radiation element further comprising a first horizontally longer section at a first end and a parallel shorter section below the first horizontally longer section, wherein the second section is proximal the ground element.

21. The antenna of claim 14 wherein the substrate is at least one of a Flame Retardant 4 material, a flexible printed circuit substrate, and a single-side printed circuit board substrate.

22. The antenna of claim 14 wherein the conductive layer is selected from the group comprising copper, aluminum, nickel, and chrome.

23. The antenna of claim 14 further comprising an insulation layer on top of the conductive layer.

24. The antenna of claim 23 wherein the insulation layer has an aperture defining a ground point exposing a portion of the ground element.

25. The antenna of claim 23 wherein the insulation layer has an aperture defining a feed point exposing a portion of the radiation element.

26. The antenna of claim 14 wherein the dual band includes a first frequency from 2400-2500 MHz and a second frequency from 4900-6000 MHz.

27. An antenna kit comprising:
a planar antenna comprising a substrate having a substantially square shape, a conductive layer attached to a first surface of the substrate wherein the conductive layer further comprises an antenna section which includes a monopole planar inverted-F antenna adapted and configured to efficiently operate in a dual band mode and a radiation control section, and a ground section connected to the inverted-F antenna by a connector region.

28. The kit of claim 27 further comprising a flexible cable adaptable to connect the planar antenna to a target device.

29. The kit of claim 27 further comprising a planar antenna mounting material.
